(19) United States
(12) Patent Application Publication
(10) Pub. No.: US 2006/0196440 A1
(43) Pub. Date: Sep. 7, 2006

(54) HATCHERY SYSTEM AND METHOD

(75) Inventors: David McMahon, Clewiston, FL (US); Michael Mogollon, Clewiston, FL (US)

Correspondence Address: Mark James Young, 12086 Fort Caroline Rd., Unit 202, Jacksonville, FL, 32225, US

(73) Assignee: OCEANBOY FARMS, INC., Clewiston, FL (US)

(21) Appl. No.: 11/308,068

(22) Filed: Mar. 5, 2006

Related U.S. Application Data
(60) Provisional application No. 60/658,766, filed on Mar. 5, 2005.

(51) Int. Cl. A01K 63/04

(52) U.S. Cl. 119/227

(57) ABSTRACT

An aquaculture hatchery for larval rearing includes a tank configured for larval rearing in water and a continuous filtration system in fluid communication with the tank. The filtration system is configured to remove ammonia from the water. A drainage system is provided for controllably draining water from the tank. A water supply system in fluid communication with the tank supplies purified water to replace drained water. An aeration system supplies pressurized air into the water containing solution of the tank for aeration and mixing. The continuous filtration system includes a pre-filter configured to prevent larvae from entering the continuous filtration system and a filter container containing biomass media and a nitrifying bacteria.

### RELATED APPLICATION

This application claims the benefit of priority of U.S. Provisional Application 60/658,766, filed Mar. 5, 2005, the entire contents of which are incorporated herein.

### FIELD OF THE INVENTION

This invention generally relates to shrimp farming, and more particularly, to an improved system and methodology for larval rearing to consistently supply required quantities of good quality postlarvae for nursery and/or growout ponds.

### BACKGROUND

Hatcheries stock nauplii (first stage larvae) until they reach a postlarvae stage. Gravid (ready-to-spawn) shrimp produce eggs, which hatch into nauplii after about a day. Nauplii feed on egg-yoke reserves for a few days and then metamorphose into zoeae, a second larval stage. Zoeae feed on algae and a variety of formulated feeds for three to five days and then metamorphose into myses, a third and final larval stage. Myses feature many characteristics of adult shrimp and feed on algae, formulated feeds and zooplankton. This stage lasts another three to four days, and then the myses metamorphose into postlarvae. Postlarvae resemble adult shrimp and feed on zooplankton, detritus and commercial feeds. When the gills of postlarvae become branched, they can be moved to a nursery pond. From hatching, it takes about 25 days to produce such postlarvae. Shrimp farms stock postlarvae shrimp from hatcheries in nursery ponds and then, several weeks later, transfer them to growout ponds.

As the saying goes, a chain is no stronger than its weakest link. This holds true in shrimp farming where hatcheries are an integral part of the shrimp farming process. The success of any shrimp farming activity is dependent on the availability of quality postlarvae shrimp in required quantity. Shrimp larvae require clean water and good nutrition for optimum growth and good health. They are easily stressed when exposed to poor water conditions such as low pH and high organic matter concentration. When stressed they are susceptible to diseases. A primary objective during the hatchery process is to provide a good quality environment to minimize stress and the attendant risk of disease, and to enhance survival rate and production.

Unfortunately, conventional hatcheries suffer several shortcomings. They typically use inadequately treated sea water and must be located close to coastal water sources for frequent replenishment. Diseases, bacteria, adverse weather, high rates of water exchange, and water quality problems adversely affect production, compromise survival rates and limit stocking densities.

The invention is directed to fulfilling one or more of the needs and overcoming one or more of the problems as set forth above.

### SUMMARY OF THE INVENTION

An object of an exemplary hatchery according to principles of the invention is to continuously filter water and remove ammonia.

Another object of an exemplary hatchery according to principles of the invention is to supply pressurized air to the water for aeration and mixing.

Yet another object of an exemplary hatchery according to principles of the invention is to purify, transport and store oceanic well water for use in the hatchery.

To achieve these and other objects and solve one or more of the problems set forth above, in an exemplary implementation of the invention, a scalable hatchery system and methodology is provided. The exemplary system employs tanks, reservoirs, purified water, aeration and filtration, to reduce the risk of diseases, harmful bacteria, and water quality problems that would otherwise adversely affect production, compromise survival rates and limit stocking densities.

An aquaculture hatchery for larval rearing according to principles of the invention includes a tank configured for larval rearing in water and a continuous filtration system in fluid communication with the tank. The filtration system is configured to remove ammonia from the water. A drainage system is provided for controllably draining water from the tank. A water supply system in fluid communication with the tank supplies purified water to replace drained water. An aeration system supplies pressurized air into the water containing solution of the tank for aeration and mixing. The continuous filtration system includes a pre-filter configured to prevent larvae from entering the continuous filtration system and a filter container containing biomass media and a nitrifying bacteria.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows an exemplary hatchery with a water supply system according to principles of the invention;

FIG. 2 shows a schematic of an exemplary filtration system according to principles of the invention; and

FIG. 3 shows an exemplary hatchery with a water supply system according to principles of the invention.

Those skilled in the art will appreciate that the invention is not limited to the exemplary embodiments depicted in the figures or the shapes, relative sizes, proportions or materials shown in the figures.

### DETAILED DESCRIPTION

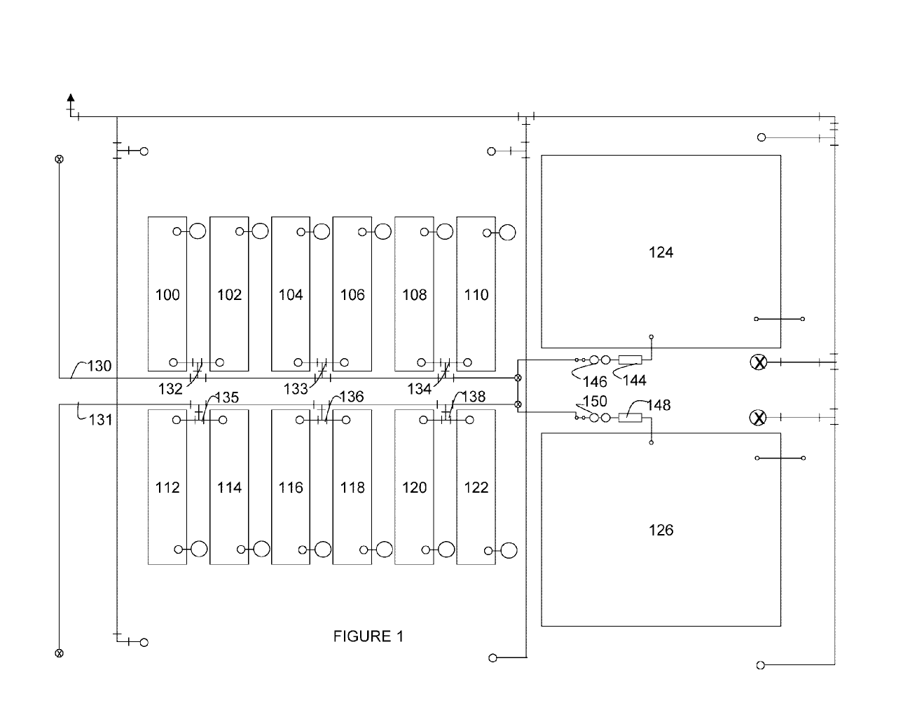

Referring to FIG. 1, an exemplary hatchery 100 according to principles of the invention is shown. The hatchery 100 includes a plurality of tanks 100-122 for larval rearing and reservoirs 124 and 126 for water supply. In the exemplary embodiment shown in FIG. 1, the tanks are rectangular in cross-section, approximately 23 feet long by 7 feet wide by ?? feet deep. Preferably, each tank includes a rounded bottom to facilitate mixing and filtration by minimizing corners and regions susceptible to accumulation and settling of waste. Advantageously, a hatchery according to the principles of the invention is scalable. Thus, the number and size of the tanks may vary depending upon the size of the hatchery operation, without departing from the scope of the invention. Additionally, the shape of the tanks may vary. Thus, tanks with other cross-sectional shapes such as round may be utilized without departing from the scope of the invention.

Water supply, filtration, and aeration systems are provided to maintain water quality and furnish a healthy environment for larvae. Advantageously, as discussed below, a hatchery according to principles of the invention requires relatively infrequent water replacement and may be located away from oceanic water supplies. Each of the aforementioned systems is discussed in greater detail below.

In a preferred implementation, oceanic well water is supplied from a well adjacent to an ocean. As used herein, an oceanic well refers to a well nearby an ocean that receives a substantial portion of its water supply from the ocean. The well water, which has been filtered through sand, tends to contain less pathogen than the ocean water. Upon removal from the well such as by pumping, the well water is filtered, chlorinated and transported to the hatchery. In an exemplary implementation, five micron and one micron particulate filters may be utilized. The water may also be chlorinated to approximately 10 ppm chlorine. Transportation may be accomplished using a pipeline if the hatchery is in the vicinity of the well. Alternatively, a tanker truck and/or rail car may be used to transport sufficient volumes of water.

Upon arrival at the hatchery, the well water may be introduced to and stored in the reservoirs 124 and 126. The reservoirs 124 and 126 have enough capacity to contain sufficient water to serve the associated tanks 100-122. While in the reservoirs 124 and 126, the water may circulate through one or more mechanical filters and activated carbon filters. Mechanical filters remove particulate from the water. The activated carbon filter removes chlorine that was introduced after removal from the well. The water may remain in the reservoir at least a sufficient time to remove substantially all chlorine from the water. The amount of time will vary depending upon operating parameters, pumping rate, filter properties and concentration of chlorine. A chlorine test may be performed periodically to determine if the water is ready for introduction into the tanks 100-122. [Para 21]With reference to FIG. 1, a plumbing schematic is also provided to conceptually show a means for introducing filtered water from the reservoirs 124 and 126 to the hatchery tanks 100-122. Valves control the flow of reservoir water to main supply lines 130 and 131 which serve the tanks 100-122 through valve controlled tank lines 132-138. Pumps 144 and 148 are provided to facilitate flow from the reservoirs 124 and 126 through filters 146 and 150 into the tanks 100-122. The plumbing includes valves to allow the water to be selectively introduced into one or more of the tanks 100-122 at a time.

Ammonia is formed from the metabolism of protein and is a major waste product of larvae. Ammonia is also formed as uneaten feed or other organic matter in a tank decomposes. High concentrations of ammonia in the water make it difficult for larvae to eliminate ammonia from their bodies and can cause stress, organ damage, death and reduced yields.

In an exemplary implementation, the water in each tank is continuously filtered. One filtration unit may serve each tank or a plurality of tanks. Biological filtration is provided to convert ammonia to nitrite NO2 and then to nitrate NO3. In a first step of the two step process, ammonia is oxidized by nitrifying bacteria in the genus Nitrosomonas or other related genera into nitrite. While nitrite is less harmful than ammonia, it can still be dangerous in quantities greater than one part per million. In a second step of the two step process, nitrite is further oxidized by nitrifying bacteria in the genus Nitrobacter or other related genera to form nitrate. The biofilter provides a substrate on which nitrifying bacteria grow. The nitrifying bacteria consume ammonia and produce nitrite, which is also toxic to fish. Other nitrifying bacteria in the biofilter consume nitrite and produce nitrate. Nitrate is not toxic to the larvae, except in very high levels, and can be diluted sufficiently through occasional water changes. This process is also called nitrification. The biofilter is configured to remove the ammonia and nitrite at a rate sufficient to prevent harmful concentrations of ammonia. The biofilter is also configured to require little maintenance, operate efficiently, and integrate with the system. Advantageously, use of the biofilter makes unnecessary the frequent water replacement which is characteristic of conventional hatchery operations.

Further reductions in potentially harmful waste products may be achieved using heterotrophic bacteria. Heterotrophic bacteria, such as bacillus species, may be introduced into the tanks 100-122 to break down complex proteins and organics (e.g., solid waste, excess food and sludge). Thus, heterotrophic bacteria metabolize waste, without interfering with colonization of nitrifying bacteria in the biofilter to convert ammonia to nitrate.

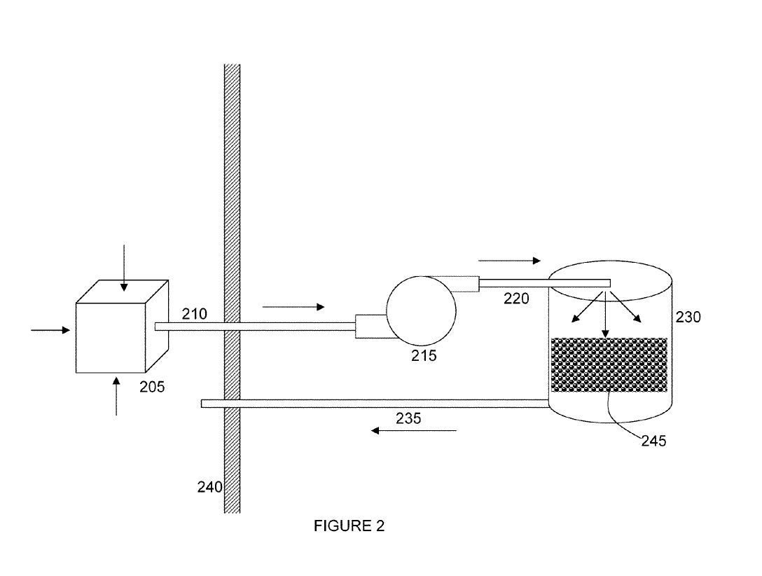

Referring now to FIG. 2, a schematic of an exemplary filtration system according to principles of the invention is shown. The system includes a pre-filter 205, a pre-filter line 210 fluidly coupling the pre-filter 205 to an inlet of a pump 215, a filter line 220 fluidly coupling an outlet of a pump 220 to an inlet of a filter container 230. A return line 235 fluidly couples an outlet of the filter container 230 to the tank 240. In operation, water is drawn from the tank 240, into the pre-filter 205, through the pre-filter line 210 and through the pump 215. The water is then expelled from the pump 215 through the filter line 220, through the filter container 230, through the return line 235 and back into the tank 240.

In an exemplary implementation, water is sprayed over biomass media 245 housed within the filter container 230. The biomass media provides a substrate upon which nitrifying bacteria may replicate. Because water passing through the biomass media 245 is pre-filtered to remove particles greater than a determined size, the filtration system of the present invention promotes substantially separate environments for the growth of heterotrophic bacteria colonies and nitrifying bacteria colonies. Heterotrophic bacteria feeds on the organic material trapped in the pre-filter 205, while nitrifying bacteria grow on the biomass media in the filter container 220. Therefore, a biological filtration system of the present invention provides an optimum environment for nitrifying bacteria colonies to grow by eliminating competition with heterotrophic bacteria that feed on organic matter.

An important aspect of the filtration system is pump and pre-filter configuration. The pump must produce adequate circulation, without trapping and killing larvae. An excessively powerful pump will trap larvae and food against the pre-filter resulting in death. An insufficiently powerful pump will not provide adequate circulation, resulting in build-up of harmful ammonia concentrations. A total ammonia level in excess of about 0.1 ppm is considered unsafe. Thus, the filtration system is configured to maintain a total ammonia level below approximately 0.1 ppm.

Based on the foregoing, for a tank having the dimensions described above, a cubic pre-filter of approximately 2 feet by 2 feet by 2 feet, comprised of a frame wrapped in netting with a mesh size of approximately 150 microns, may be fluidly coupled to a 60 gpm pump. As such a configuration produces relatively little suction, it does not trap larvae. However, the configuration produces adequate circulation to prevent harmful nitrogen concentrations in a XXX cubic foot tank. The pre-filter and pump configuration may be adjusted, such as by scaling in size and pumping capacity to achieve acceptable results.

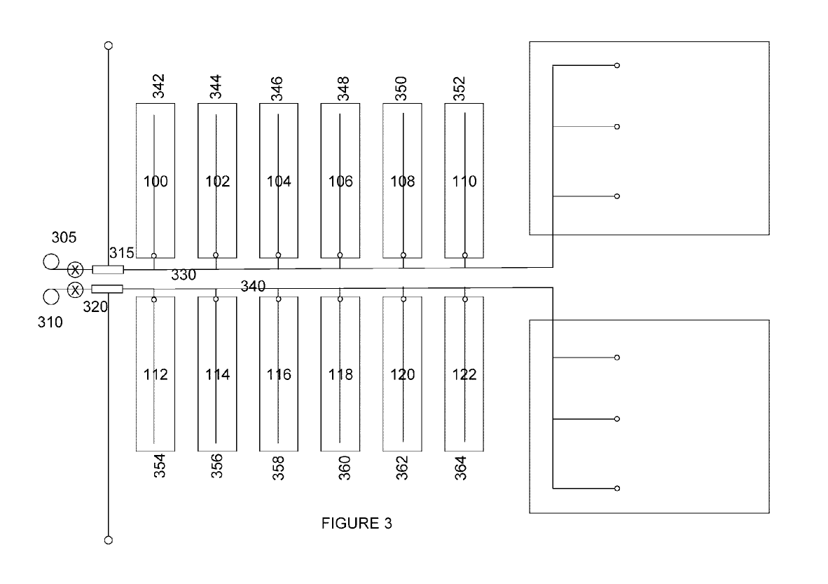

Referring now to FIG. 3, an aeration schematic is provided to conceptually show a means for introducing air from blowers 305 and 310, through filters 315 and 320 to the hatchery tanks 100-122. Valves control the flow of reservoir water to main aeration lines 330 and 340 which serve the tanks 100-122 through valve controlled tank aeration lines 342-364. The aeration plumbing includes valves to allow pressurized air to be selectively introduced into one or more of the tanks 100-122 at a time.

The aeration system serves several purposes. It provides mixing action and helps supply oxygen required to achieve maximum yields. Dissolved oxygen is a particularly important aspect of water quality in raising larvae. The aeration system helps replenish oxygen in the water as it is depleted by larvae. Thus, chronically low levels of dissolved oxygen (e.g., less than 3 ppm) that may result in less than anticipated yields can be avoided. Introduction of pressurized air also produces a churning and mixing action that disburses food and helps prevent food and waste from settling on the bottom of the tanks.

Advantageously, the aeration, filtration and water supply systems enable successful hatchery operations with infrequent replacement of water in the tanks 100-122. Contaminated water may be expelled from a tank using a filtered drainage system (not shown) with plumbing that allows water, but not larvae, to pass through to a suitable collection well. By way of example and not limitation, while a conventional hatchery may replace all water in a tank on a daily basis, a hatchery according to the principles of the invention may requires replacement of water in the tanks half as frequently or less. This results in less waste, enhanced efficiency, reduced stress to larvae and higher yields. Concomitantly, recycling water in accordance with principles of the present invention helps to preserve levels of beneficial pheromones secreted during maturation.

While the invention has been described in terms of various embodiments and implementations, those skilled in the art will recognize that the invention can be practiced with modification within the spirit and scope of the appended claims.

What is claimed is:

1. An aquaculture hatchery for larval rearing, said hatchery comprising a tank configured for larval rearing in water containing solution; a continuous filtration system in fluid communication with said tank, said filtration system being configured to remove ammonia from said water containing solution.

2. The hatchery of claim 1, further comprising a drainage system for draining at least a portion of the water containing solution from the tank, and a water supply system in fluid communication with the tank and configured to supply purified water containing solution to replace at least a portion of the drained water containing solution.

3. The hatchery of claim 1, further comprising an aeration system configured to supply pressurized air into the water containing solution of the tank.

4. The hatchery of claim 1, wherein the continuous filtration system includes a pre-filter, said pre-filter being configured to prevent larvae from entering the continuous filtration system.

5. The hatchery of claim 1, wherein the continuous filtration system includes a filter container, said filter container containing biomass media and a nitrifying bacteria.

6. The hatchery of claim 1, further comprising a drainage system for draining at least a portion of the water containing solution from the tank; a water supply system in fluid communication with the tank and configured to supply purified water containing solution to replace at least a portion of the drained water containing solution; and an aeration system configured to supply pressurized air into the water containing solution of the tank.

7. The hatchery of claim 6, wherein the continuous filtration system includes a pre-filter, said pre-filter being configured to prevent larvae from entering the continuous filtration system.

8. The hatchery of claim 7, wherein the continuous filtration system includes a filter container, said filter container containing biomass media and a nitrifying bacteria.

9. An aquaculture hatchery for larval rearing, said hatchery comprising a tank configured for larval rearing in water containing solution, a means for continuously filtering the water containing solution in said tank, said means for continuously filtering the water containing solution being configured to remove ammonia from said water containing solution.

10. The hatchery of claim 9, further comprising a means for draining at least a portion of the water containing solution from the tank, and a means for supplying a purified water containing solution to said tank to replace at least a portion of drained water containing solution.

11. The hatchery of claim 9, further comprising a means for supplying pressurized air into the water containing solution of the tank.

12. The hatchery of claim 9, wherein the means for continuously filtering the water containing solution includes a pre-filter, said pre-filter being configured to prevent larvae from entering the continuous filtration system.

13. The hatchery of claim 9, wherein the means for continuously filtering the water containing solution includes a filter container, said filter container containing biomass media and a nitrifying bacteria.

14. The hatchery of claim 9, further comprising a means for draining at least a portion of the water containing solution from the tank, and a means for supplying a purified water containing solution to said tank to replace at least a portion of drained water containing solution; and a means for supplying pressurized air into the water containing solution of the tank.

15. The hatchery of claim 14, wherein the means for continuously filtering the water containing solution includes a pre-filter, said pre-filter being configured to prevent larvae from entering the continuous filtration system.

16. The hatchery of claim 15, wherein the means for continuously filtering the water containing solution includes a filter container, said filter container containing biomass media and a nitrifying bacteria.

17. An aquaculture hatchery methodology, said methodology comprising steps of purifying a water containing solution from an oceanic well; introducing the purified water containing solution into a tank configured for larval rearing; introducing larvae into the tank; and continuously filtering the water containing solution in said tank, including removing ammonia from said water containing solution.

18. The aquaculture hatchery methodology of claim 17, further comprising draining at least a portion of the water containing solution from the tank, and supplying a purified water containing solution to said tank to replace at least a portion of drained water containing solution.

19. The aquaculture hatchery methodology of claim 17, further comprising supplying pressurized air into the water containing solution of the tank.

20. The hatchery of claim 9, wherein the step of continuously filtering the water containing solution in said tank includes pre-filtering the water containing solution and passing the pre-filtered water containing solution over a biomass media and a nitrifying bacteria.
